(19) United States
(12) Patent Application Publication
(10) Pub. No.: US 2026/0153866 A1
(43) Pub. Date: Jun. 4, 2026

(54) METHOD AND APPARATUS FOR CONTROLLING AUTOMATIC CLEANING DEVICE, AND AUTOMATIC CLEANING DEVICE

(71) Applicant: Beijing Roborock Innovation Technology Co., Ltd., Beijing (CN)

(72) Inventor: Kaijing WANG, Beijing (CN)

(73) Assignee: Beijing Roborock Innovation Technology Co., Ltd., Beijing (CN)

(21) Appl. No.: 19/459,105

(22) Filed: Jan. 26, 2026

Related U.S. Application Data
(63) Continuation of application No. PCT/CN2024/125513, filed on Oct. 17, 2024.

(30) Foreign Application Priority Data
Aug. 25, 2023 (CN) 202311085420.X

(51) Int. Cl. G05D 1/229; G05D 1/246; G05D 1/617; G05D 1/628; G05D 105/10

(52) U.S. Cl. CPC G05D 1/2295; G05D 1/246; G05D 1/619; G05D 1/628; G05D 2105/10

(57) ABSTRACT

The present application discloses a method and apparatus for controlling an automatic cleaning device, and an automatic cleaning device. The method includes: the automatic cleaning device enters a protection mode when entering a preset region, wherein a corresponding parameter for traveling along an obstacle changes from a first parameter to a second parameter, and the first parameter is an initial parameter in a non-protection mode.

### CROSS REFERENCE TO RELATED APPLICATION

This application is a continued application of copending PCT application No. PCT/CN 2024/125513, filed on Oct. 17, 2024, which claims priority to Chinese Patent Application No. 202311085420.X, filed on Aug. 25, 2023, the disclosure of which is incorporated herein by reference in its entirety as part of the present application.

### TECHNICAL FIELD

The present application relates to the technical field of automatic cleaning devices, in particular to a method and apparatus for controlling an automatic cleaning device, and an automatic cleaning device.

### BACKGROUND

An automatic cleaning device, also known as an automatic sweeping and mopping machine, a sweeping robot, a smart vacuuming and sweeping machine, a vacuum cleaner, or the like, is a type of smart household appliance that can automatically complete floor cleaning in a room by means of a certain level of artificial intelligence. The automatic cleaning device generally sucks debris on a floor into its own garbage storage box first via brushing and vacuuming, thereby completing a floor cleaning function. Generally, devices that automatically complete cleaning, vacuuming and mopping are also classified as automatic cleaning devices.

One of common problems in using an automatic cleaning device is that the automatic cleaning device often collides with obstacles during operation due to complex environments, which in turn affects sweeping efficiency. Since the automatic cleaning device cannot avoid the obstacles, it keeps moving forward and crashing into the obstacles. This not only increases losses, but also makes the automatic cleaning device prone to breaking, which in turn makes the automatic cleaning device inconvenient to maintain and use subsequently. How to avoid damage to the automatic cleaning device and articles in complex environments caused by collision with obstacles in these environments is an urgent problem that needs to be resolved.

### SUMMARY

Aimed at the above situations, embodiments of the present application provide a control method of an automatic cleaning device and an obstacle avoiding control apparatus to resolve the problems that automatic cleaning devices available on the market are short in service life due to collisions and cannot adapt to complex wall environments.

In a first aspect, a method for controlling an automatic cleaning device is provided according to the embodiments of the present application. The method includes:

in response to the automatic cleaning device entering a protection mode upon entering a preset area, changing a corresponding parameter of obstacle-following traveling from a first parameter to a second parameter, wherein the first parameter is an initial parameter in a non-protection mode.

In a second aspect, an apparatus for controlling an automatic cleaning device is further provided according to the embodiments of the present application. The apparatus includes: a protection module configured to: in response to the automatic cleaning device entering a protection mode upon entering a preset area, change a corresponding parameter of obstacle-following traveling from a first parameter to a second parameter, wherein the first parameter is an initial parameter in a non-protection mode.

In a third aspect, an automatic cleaning device is further provided according to the embodiments of the present application. The automatic cleaning device includes an automatic cleaning device body and a control apparatus for controlling the automatic cleaning device body, wherein the control apparatus adopts the method for controlling an automatic cleaning device in the first aspect.

In a fourth aspect, a non-transitory storage medium storing a computer program is provided. The computer program, when run by a processor, causes the processor to perform the above method for controlling the automatic cleaning device.

### BRIEF DESCRIPTION OF DRAWINGS

The accompanying drawings described herein are intended to provide further understanding of the present application, and constitute a part of the present application. Exemplary embodiments of the present application and descriptions thereof are intended to explain the present application, but do not constitute inappropriate limitations to the present application. In the accompanying drawings:

FIG. 1 is a schematic flowchart of a method for controlling an automatic cleaning device according to a first embodiment of the present application;

FIG. 2 is a schematic structural diagram of an apparatus for controlling an automatic cleaning device according to a second embodiment of the present application;

FIG. 3 is a schematic structural diagram of an automatic cleaning device according to a third embodiment of the present application;

FIG. 4 is a schematic diagram of a wall-following advancing direction of an automatic cleaning device;

FIG. 5 is a schematic diagram of a wall-following turning direction of an automatic cleaning device;

FIG. 6 is a schematic diagram of a wall-following protection mode of an automatic cleaning device;

FIG. 7 is a schematic diagram of a wall-following dynamic protection mode of an automatic cleaning device; and

FIG. 8 is a schematic diagram of an automatic cleaning device in turning.

### DETAILED DESCRIPTION

To make the objectives, technical solutions, and advantages of the present application clearer, the technical solutions of the present application are clearly and completely described below with reference to specific embodiments of the present application and corresponding accompanying drawings. Apparently, the described embodiments are merely some rather than all of the embodiments of the present application. All other embodiments obtained by those of ordinary skill in the art based on the embodiments of the present application without creative efforts shall fall within the protection scope of the present application.

The technical solutions provided in the embodiments of the present application are described in detail below with reference to the accompanying drawings.

An automatic cleaning device, also known as an automatic sweeping and mopping machine, an automatic cleaning device, a smart vacuuming and sweeping machine, a sweeping robot, a mobile automatic cleaning device, or the like, is a type of smart household appliance that can automatically complete floor cleaning in a room by means of a certain level of artificial intelligence. The automatic cleaning device generally sucks debris on a floor into its own garbage storage box first via brushing and vacuuming, thereby completing a floor cleaning function. Generally, devices that automatically complete cleaning, vacuuming and mopping are also classified as automatic cleaning devices.

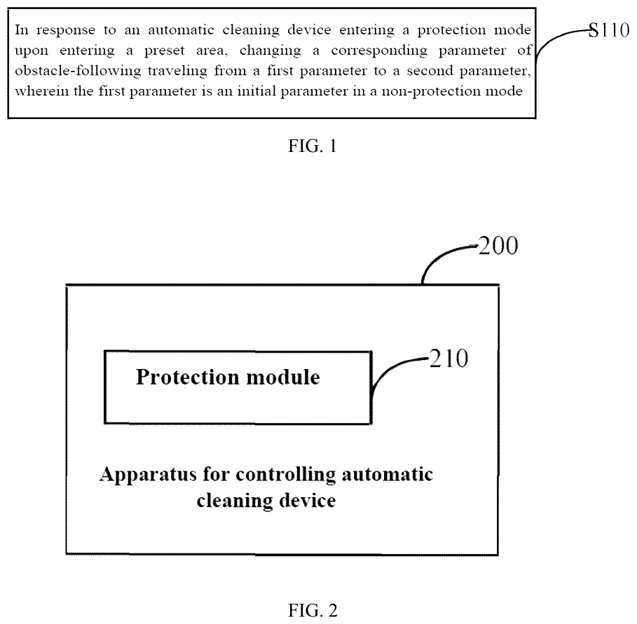

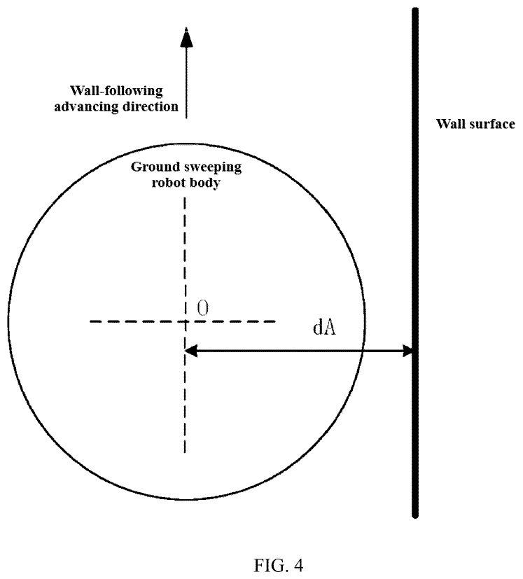

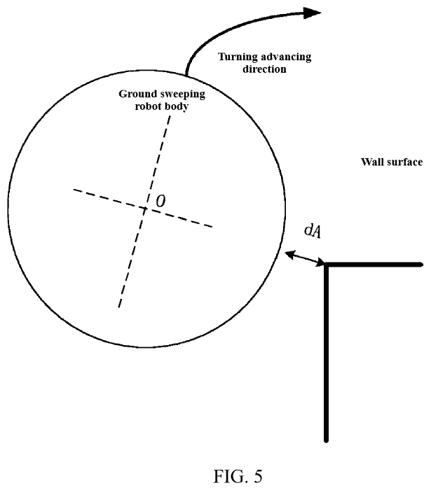

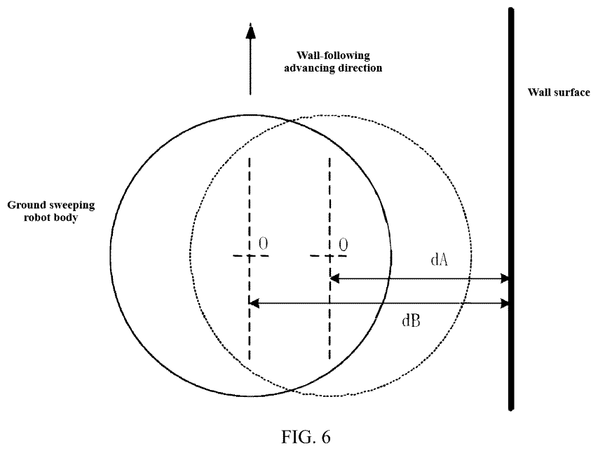

As shown in FIG. 1 to FIG. 8, FIG. 4 is a schematic diagram of a wall-following advancing direction of an automatic cleaning device; and FIG. 5 is a schematic diagram of a turning direction of an automatic cleaning device. The automatic cleaning device achieves edge cleaning primarily through wall-following traveling and turning. In the two states, by fusing data from various range sensors and using an algorithm to control its own motion posture, the automatic cleaning device ensures that the distance between a device body and a target wall surface always remains at a target distance dA, which in turn ensures that the device can not only travel smoothly along the target wall surface, but also complete cleaning of a wall corner, thereby avoiding scratching the wall surface.

It should be noted that “wall” in the term “wall-following” of the so-called wall-following movement of the automatic cleaning device in the present application may be a strictly linear wall, or may include a non-linear wall having a small-radian wall surface. That is, all movements of a self-walking device along a linear wall or a non-linear wall having a small-radian wall surface are classified as the “wall-following” movements. In addition, the so-called “turning” movement may be understood as a movement of the self-walking device at a large-radian position (including a right-angle turning) of a wall surface, that is, a movement along a large-radian wall surface is regarded as turning. During normal cleaning of the device, the target distance dA is fixed in all scenarios and is not modified. This causes the following problem: In response to the environment of a user's house being relatively complex, for example, the wall surface being not a flat vertical wall, but having a bulge at a height that is undetectable by a sensor, the original target distance dA may be too small, causing the device to scratch against a raised obstacle in the user's house. Over time, the user's furniture may be damaged by the automatic cleaning device, which in turn causes unnecessary losses.

In view of this, the present application is hereby proposed. The concept of the present application is as follows: First, a user is allowed to select a new protection mode through an APP to trigger a wall-following movement and a turning movement that have a target distance dB farther than the target distance dA; and second, in response to the protection mode being enabled, the automatic cleaning device further dynamically adjusts the predetermined distance dB to a farther target distance dC under certain conditions to further protect the furniture.

Specific implementations are as follows, which may be described from three scenarios: a wall-following movement, a turning movement, and a turning and wall-following movement.

FIG. 1 is a schematic flowchart of a method for controlling an automatic cleaning device according to a first embodiment of the present application. This method is applicable to a wall-following cleaning scenario. As can be seen from FIG. 1, the present application includes at least step S110.

In step S110, in response to the automatic cleaning device entering a protection mode upon entering a preset area, a corresponding parameter of obstacle-following traveling is changed from a first parameter to a second parameter, wherein the first parameter is an initial parameter in a non-protection mode.

In the embodiments, the preset area is acquired via intelligent recognition or manual configuration performed by a user based on a map established by the automatic cleaning device.

Step S110 further includes: in the protection mode, increasing the first parameter used for controlling the automatic cleaning device to avoid colliding with an obstacle to the second parameter, since the obstacle-following traveling includes wall-following traveling.

In response to the obstacle-following traveling being the wall-following traveling, the first parameter is a target distance dA of the automatic cleaning device from a wall surface, and the second parameter is a target distance dB of the automatic cleaning device from the wall surface, wherein the target distance dB is greater than the target distance dA.

When the automatic cleaning device keeps advancing at a fixed distance relative to a current wall surface A, namely, the so-called wall-following traveling, the device needs to acquire information about the distance from the wall surface A through a sensor of the automatic cleaning device, to ensure the sweeping effect of the automatic cleaning device on an edge of the wall surface A. The sensor used in this case may be a wall-following sensor (wall sensor/light touch), a laser sensor (LDS), or a vision sensor (Tof, structured light, line laser, or the like). By using the above sensor, in this step, the target distance dA of the automatic cleaning device from the wall surface (also referred to as a wall-following distance) may be understood as the distance between the center of the automatic cleaning device and the wall surface A.

In an actual application scenario, the user may enable the protection mode through the APP of the automatic cleaning device to control the automatic cleaning device to move away from the current wall surface, such that the target distance dA of the automatic cleaning device from the current wall surface is increased to the target distance dB, and then wall surface protection of a first stage is performed.

In step S120, the corresponding parameter of the obstacle-following traveling is changed from the second parameter to a third parameter based on a frequency of collision between the automatic cleaning device and an obstacle, wherein the third parameter is a target distance dC of the automatic cleaning device from the wall surface.

After the automatic cleaning device enters the protection mode, the wall-following target distance is changed to the target distance dB. There is also a dynamic protection mode. In the dynamic protection mode, the corresponding parameter of the obstacle-following traveling is increased from the second parameter to the third parameter based on the frequency of collision between the automatic cleaning device and the obstacle. In response to the obstacle-following traveling being the wall-following traveling, in the dynamic protection mode, the third parameter is the target distance dC of the automatic cleaning device from the wall surface, wherein the target distance dC is greater than the target distance dB.

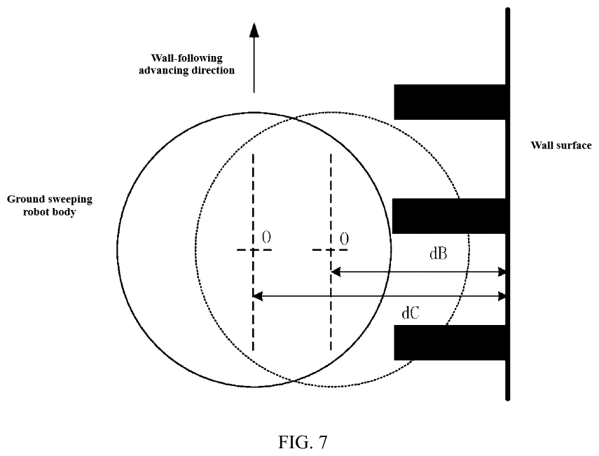

In a specific scenario, step S120 is performed in the dynamic protection mode. Referring to FIG. 7, FIG. 7 is a schematic diagram of a wall-following dynamic protection mode of an automatic cleaning device. In step S120, a heading angle of the device is monitored based on IMU (Inertial Measurement Unit)) data. When a change value of the heading angle of the automatic cleaning device is less than a preset value (for example, the heading angle change value is less than 15°), triggering a bumper a plurality of times continuously (more than 2 to 3 times) within 1 to 2 meters'advancing of the automatic cleaning device may indicate that if the distance of the automatic cleaning device from a certain wall surface is the distance dB, the automatic cleaning device scratches the wall surface. In this case, the distance between the automatic cleaning device and the wall surface is gradually increased. That is, the target distance dB of the automatic cleaning device from the wall surface is increased to the target distance dC. As the distance is adjusted dynamically, the user's furniture is protected.

In a possible implementation, the preset value of the change value of the heading angle is less than 15°.

FIG. 4 is a schematic flowchart of a method for controlling an automatic cleaning device according to a second embodiment of the present application. The method is applicable to a turning cleaning scenario of the automatic cleaning device. As can be seen from FIG. 4, the present application includes at least step S210.

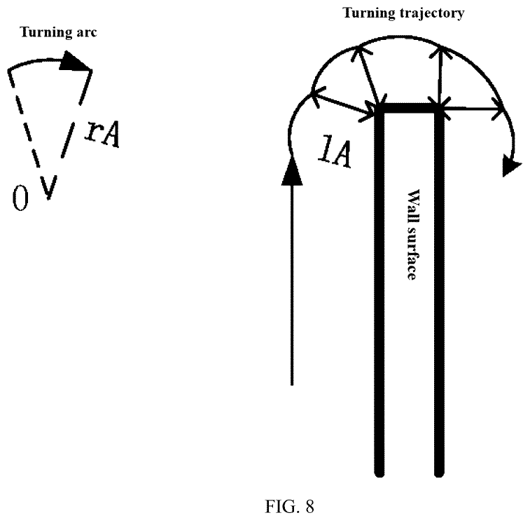

In this step, turning of the automatic cleaning device is completed by designing a fixed turning arc radius. That is, no matter whether the device attempts to bypass a post or a wall corner, the automatic cleaning device is controlled to travel an arc with a fixed turning radius, and then a plurality of such arc movements are joined together to complete the turning. There are two key parameters used for controlling a turning process of the automatic cleaning device, namely, a turning radius rA and a distance of an arc continuation point from a corner. A larger value of the turning radius rA leads to a farther distance from a target object during turning. The target object is the corner. For example, in response to the corner being a 90° wall corner or a straight corner, the distance lA of the arc continuation point from the corner may be understood as the distance of the arc continuation point from the intersection point of the straight corner, as shown in FIG. 8. FIG. 8 is a schematic diagram of an automatic cleaning device in turning.

It should be noted that an arc continuation point is the intersection point of adjacent arcs, wherein the arcs are formed when the automatic cleaning device travels once according to the preset turning arc radius rA.

In step S210, in response to the automatic cleaning device entering a protection mode upon entering a preset area, a corresponding parameter of obstacle-following traveling is changed from a first parameter to a second parameter, wherein the first parameter is an initial parameter in a non-protection mode.

Step S210 specifically includes: in response to the obstacle-following traveling being the turning, setting the first parameter to include a turning arc radius rA and a distance lA between an arc continuation point and a turning point, and the second parameter to include a turning arc radius rB and a distance lB between an arc continuation point and a turning point; and in response to the automatic cleaning device enabling the protection mode, the turning arc radius rA and the distance lA between the arc continuation point and the turning point are increased to rB and lB, respectively.

In step S220, the turning is completed, and a forward direction of the automatic cleaning device is adjusted to be closer to a parallel line where a new wall surface is located than at a previous moment.

The following steps are further included in step S220.

In step S221, the automatic cleaning device completes turning and keeps advancing in a current direction for a buffer distance.

In step S222, within the buffer distance, the automatic cleaning device is controlled to advance at a first forward speed and a first rotational speed, such that the forward direction of the automatic cleaning device is more oriented towards a wall surface than at the previous moment.

In step S223, after the buffer distance is completed, the automatic cleaning device is controlled to advance at a second forward speed and a second rotational speed, such that the forward direction of the automatic cleaning device is closer to the parallel line where the new wall surface is located than at the previous moment.

Because the distance from the wall is increased during turning, when the automatic cleaning device completes turning and turns to the new wall surface, if the new wall surface is not within the range of the protection mode, a target wall-following distance is relatively short, or the previous distance from the wall during turning is relatively far, and even exceeds a wall-following protection distance dB. In this case, if the device is directly controlled to move close to the wall surface from a far position, the device may hit the wall surface due to an excessively high approaching speed. Therefore, it is necessary to subsequently control the device to dynamically control the target wall-following distance, such that the device approaches the wall surface slowly, which not only protects the wall surface but also reduces missed sweeping.

Specifically, after the automatic cleaning device completes turning, a buffer distance L1 is preset first. Within the buffer distance L1, a PID (Proportional-Integral-Derivative) control apparatus is used to control the first forward speed and the first rotational speed of the automatic cleaning device based on a first-section PID control parameter, to ensure that the automatic cleaning device can gradually transition from a posture advancing towards the wall surface from a long distance to a posture stably advancing parallel to the new wall surface while maintaining a long distance from the wall. Within the buffer distance L1, a target distance between the automatic cleaning device and the new wall surface is acquired in real time by using a wall-following sensor.

Subsequently, after the automatic cleaning device completes the buffer distance L1, the target distance dA between the automatic cleaning device and the new wall surface is reduced, and the PID control apparatus is used to control the automatic cleaning device to get close to the wall surface. Specifically, a second-section PID control parameter is enabled. A PID apparatus is used to control the second forward speed and the second rotational speed of the automatic cleaning device based on the preset second-section PID control parameter, such that the forward direction of the automatic cleaning device is closer to the parallel line where the new wall surface is located than at the previous moment. The automatic cleaning device is controlled to gradually approach the wall surface in an advancing process, thereby achieving a stable advancing state near a new wall-following distance and a smooth transition.

The reason for this approach is that the final distance from the wall surface is very short. If one set of PID control parameters is directly used to control the automatic cleaning device to approach the wall surface to a final target distance, the automatic cleaning device would overshoot the target distance and get too close to the wall surface due to oscillation in the controlling process. Consequently, the automatic cleaning device scratches or even bumps into the wall surface.

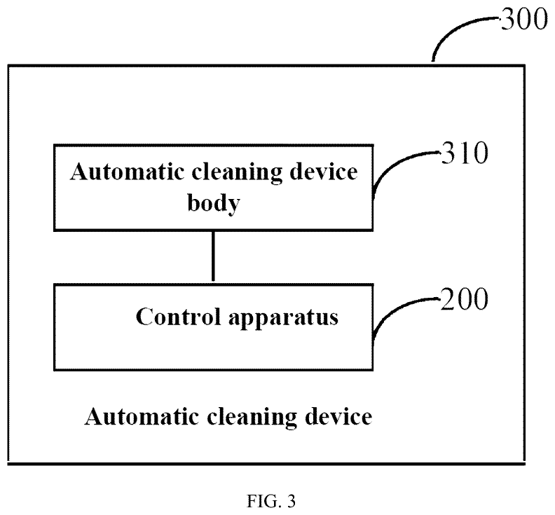

FIG. 3 is a schematic structural diagram of a control apparatus of an automatic cleaning device according to a third embodiment of the present application. The control apparatus is applied to the automatic cleaning device. As can be seen from FIG. 3, the control apparatus 300 includes: a protection module 210 configured to: in response to the automatic cleaning device entering a protection mode upon entering a preset area, change a corresponding parameter of obstacle-following traveling from a first parameter to a second parameter, wherein the first parameter is an initial parameter in a non-protection mode.

In a possible implementation, the protection module 210 is further configured to: in the protection mode, increase the first parameter used for controlling the automatic cleaning device to avoid collision with an obstacle to the second parameter since the obstacle-following traveling includes wall-following traveling or turning movement.

In a possible implementation, the protection module 210 is further configured to: acquire the preset area via intelligent recognition or manual configuration performed by a user based on a map established by the automatic cleaning device.

In a possible implementation, the protection module 210 is further configured to: in response to the obstacle-following traveling being wall-following traveling, set the first parameter to a target distance dA of the automatic cleaning device from a wall surface, and set the second parameter to a target distance dB of the automatic cleaning device from the wall surface, wherein the target distance dB is greater than the target distance dA.

In a possible implementation, the protection module 210 is further configured to: in response to the obstacle-following traveling being wall-following traveling, and the automatic cleaning device enabling a dynamic protection mode, in the dynamic protection mode, increase the corresponding parameter of the obstacle-following traveling from the second parameter to a third parameter based on the frequency of collision between the automatic cleaning device and the obstacle.

In a possible implementation, the protection module 210 is further configured to: in response to the obstacle-following traveling being wall-following traveling, in the dynamic protection mode, set the third parameter to a target distance dC of the automatic cleaning device from the wall surface, wherein the target distance dC is greater than the target distance dB.

In a possible implementation, the protection module 210 is further configured to: in response to the obstacle-following traveling being turning, set the first parameter to include a turning arc radius rA and a distance lA between an arc continuation point and a turning point, and the second parameter to include a turning arc radius rB and a distance lB between an arc continuation point and a turning point; and in response to the automatic cleaning device enabling the protection mode, increase the turning arc radius rA and the distance lA between the arc continuation point and the turning point to rB and lB, respectively.

In a possible implementation, the protection module 210 is further configured to: in response to the obstacle-following traveling being an operation after completion of the turning, keep the automatic cleaning device advancing in a current direction for a buffer distance.

In a possible implementation, the protection module 210 is further configured to: within the buffer distance, control the automatic cleaning device to advance at a first forward speed and a first rotational speed, such that a forward direction of the automatic cleaning device is more oriented towards a wall surface than at a previous moment.

In a possible implementation, the protection module 210 is further configured to: after the buffer distance is completed, control the automatic cleaning device to advance at a second forward speed and a second rotational speed, such that the forward direction of the automatic cleaning device is closer to the parallel line where the new wall surface is located than at the previous moment.

It should be noted that the foregoing control apparatus can implement the foregoing methods for controlling an automatic cleaning device according to the second embodiment one by one, and technical features that are the same as those of the method for controlling an automatic cleaning device are not repeated herein.

The present application further discloses an automatic cleaning device according to a fifth embodiment. The automatic cleaning device 300 includes an automatic cleaning device body 310 and a control apparatus 200 for controlling the automatic cleaning device body. The control apparatus adopts the foregoing method for controlling an automatic cleaning device according to the first embodiment.

Based on the above method, correspondingly, one embodiment of the present disclosure also provides a non-transitory storage medium storing a computer program. The program, when run by a processor, causes the processor to perform the above method for controlling the automatic cleaning device.

Solutions of the present application enable the automatic cleaning device to adapt to complex environments. By fusing data from various range sensors and using an algorithm to control its own motion posture, the automatic cleaning device ensures that the distance between itself and a target wall surface always remains at a target distance dA, which in turn ensures that the device can not only travel smoothly along the target wall surface, but also complete cleaning of a wall corner, thereby avoiding scratching the wall surface.

The foregoing apparatus embodiment corresponds to the method embodiment, and has the same technical effect as the method embodiment. For detailed descriptions, refer to the method embodiment. The apparatus embodiment is derived based on the method embodiment. For detailed descriptions, refer to the method embodiment section. Details are not repeated herein. Those of ordinary skill in the art may understand that the accompanying drawing is merely a schematic diagram of an embodiment, and modules or processes in the accompanying drawing are not necessarily essential for implementing the present application.

Those of ordinary skill in the art may understand that the modules of the apparatus in the embodiment may be distributed in the apparatus in this embodiment according to the description of this embodiment, or may be changed accordingly and disposed in one or more apparatuses different from the apparatus in this embodiment. The modules in the foregoing embodiment may be combined into one module, or may be further split into a plurality of sub-modules.

Finally, it should be noted that the foregoing embodiments are only used to illustrate, instead of limiting, the technical solutions of the present application. Although the present application is described in detail with reference to the foregoing embodiments, it may be understood by those of ordinary skill in the art that they can still make modifications to the technical solutions described in the foregoing embodiments or equivalent replacements on some of the technical features, and these modifications or replacements do not depart the essence of the corresponding technical solution from the spirit and scope of the technical solutions of the embodiments of the present application.

1. A method for controlling an automatic cleaning device, comprising:
entering a protection mode in response that the automatic cleaning device enters a preset area, wherein a corresponding parameter of obstacle-following traveling changes from a first parameter to a second parameter, the first parameter is an initial parameter in a non-protection mode.

2. The method according to claim 1, wherein
the obstacle-following traveling comprises wall-following traveling or turning; and in the protection mode, the first parameter used for controlling the automatic cleaning device to avoid colliding with an obstacle is increased to the second parameter.

3. The method according to claim 1, wherein the preset area is acquired via intelligent recognition or manual configuration performed by a user based on a map established by the automatic cleaning device.

4. The method according to claim 2, wherein in response that the obstacle-following traveling is the wall-following traveling, the first parameter is a target distance dA of the automatic cleaning device from a wall surface, and the second parameter is a target distance dB of the automatic cleaning device from the wall surface, wherein the target distance dB is greater than the target distance dA.

5. The method according to claim 2, wherein in response that the obstacle-following traveling is the wall-following traveling, and the automatic cleaning device enables a dynamic protection mode, in the dynamic protection mode, the corresponding parameter of the obstacle-following traveling is increased from the second parameter to a third parameter based on a frequency of collision between the automatic cleaning device and an obstacle.

6. The method according to claim 5, wherein in response that the obstacle-following traveling is the wall-following traveling, in the dynamic protection mode, the third parameter is a target distance dC of the automatic cleaning device from the wall surface, wherein the target distance dC is greater than the target distance dB.

7. The method according to claim 2, wherein in response that the obstacle-following traveling is the turning, the first parameter comprises a turning arc radius rA and a distance lA between an arc continuation point and a turning point, and the second parameter comprises a turning arc radius rB and a distance lB between an arc continuation point and a turning point; and
response that the automatic cleaning device enables the protection mode, the turning arc radius rA and the distance lA between the arc continuation point and the turning point are increased to rB and lB, respectively.

8. The method according to claim 7, wherein in response that the obstacle-following traveling is an operation after completion of the turning, the automatic cleaning device keeps advancing in a current direction for a buffer distance; and
within the buffer distance, the automatic cleaning device is controlled to advance at a first forward speed and a first rotational speed, such that a forward direction of the automatic cleaning device is more oriented towards a wall surface than at a previous moment.

9. The method according to claim 8, wherein after the buffer distance is completed, the automatic cleaning device is controlled to advance at a second forward speed and a second rotational speed, such that the forward direction of the automatic cleaning device is closer to a parallel line where a new wall surface is located than at the previous moment.

10. An apparatus for controlling an automatic cleaning device, comprising: a protection module configured to: enter a protection mode in response that the automatic cleaning device enters a preset area, wherein a corresponding parameter of obstacle-following traveling changes from a first parameter to a second parameter, the first parameter is an initial parameter in a non-protection mode.

11. An automatic cleaning device, comprising an automatic cleaning device body and a control apparatus for controlling the automatic cleaning device body, wherein the control apparatus is configured to: enter a protection mode in response that the automatic cleaning device enters a preset area, wherein a corresponding parameter of obstacle-following traveling changes from a first parameter to a second parameter, the first parameter is an initial parameter in a non-protection mode.

12. The automatic cleaning device according to claim 11, wherein
the obstacle-following traveling comprises wall-following traveling or turning; and in the protection mode, the first parameter used for controlling the automatic cleaning device to avoid colliding with an obstacle is increased to the second parameter.

13. The automatic cleaning device according to claim 11, wherein the preset area is acquired via intelligent recognition or manual configuration performed by a user based on a map established by the automatic cleaning device.

14. The automatic cleaning device according to claim 12, wherein in response that the obstacle-following traveling is the wall-following traveling, the first parameter is a target distance dA of the automatic cleaning device from a wall surface, and the second parameter is a target distance dB of the automatic cleaning device from the wall surface, wherein the target distance dB is greater than the target distance dA.

15. The automatic cleaning device according to claim 12, wherein in response that the obstacle-following traveling is the wall-following traveling, and the automatic cleaning device enables a dynamic protection mode, in the dynamic protection mode, the corresponding parameter of the obstacle-following traveling is increased from the second parameter to a third parameter based on a frequency of collision between the automatic cleaning device and an obstacle.

16. The automatic cleaning device according to claim 15, wherein in response that the obstacle-following traveling is the wall-following traveling, in the dynamic protection mode, the third parameter is a target distance dC of the automatic cleaning device from the wall surface, wherein the target distance dC is greater than the target distance dB.

17. The automatic cleaning device according to claim 12, wherein in response that the obstacle-following traveling is the turning, the first parameter comprises a turning arc radius rA and a distance lA between an arc continuation point and a turning point, and the second parameter comprises a turning arc radius rB and a distance lB between an arc continuation point and a turning point; and in response that the automatic cleaning device enables the protection mode, the turning arc radius rA and the distance lA between the arc continuation point and the turning point are increased to rB and lB, respectively.

18. The automatic cleaning device according to claim 17, wherein in response that the obstacle-following traveling is an operation after completion of the turning, the automatic cleaning device keeps advancing in a current direction for a buffer distance; and
within the buffer distance, the automatic cleaning device is controlled to advance at a first forward speed and a first rotational speed, such that a forward direction of the automatic cleaning device is more oriented towards a wall surface than at a previous moment.

19. The automatic cleaning device according to claim 18, wherein after the buffer distance is completed, the automatic cleaning device is controlled to advance at a second forward speed and a second rotational speed, such that the forward direction of the automatic cleaning device is closer to a parallel line where a new wall surface is located than at the previous moment.

20. A non-transitory storage medium storing a computer program, wherein the computer program, when run by a processor, causes the processor to perform the method for controlling an automatic cleaning device according to claim 1.
